(19) United States
(12) Patent Application Publication
(10) Pub. No.: US 2019/0012302 A1
(43) Pub. Date: Jan. 10, 2019

(54) ANNOTATIONS OF TEXTUAL SEGMENTS BASED ON USER FEEDBACK

(71) Applicant: Google Inc., Mountaina View, CA (US)

(72) Inventors: Matt MacMahon, Sunnyvale, CA (US); Tania Bedrax Weiss, Sunnyvale, CA (US)

(21) Appl. No.: 14/640,591

(22) Filed: Mar. 6, 2015

Related U.S. Application Data
(60) Provisional application No. 62/066,208, filed on Oct. 20, 2014.

(51) Int. Cl. G06F 17/24; G06F 17/30

(52) U.S. Cl. CPC G06F 17/241; G06F 17/30882

(57) ABSTRACT

Methods and apparatus related to verifying annotations of textual segments based on human feedback that is responsive to questions generated to solicit feedback relevant to the annotations. Some implementations are directed generally to generating one or more task specifications to solicit feedback relevant to a potential annotation of a target textual segment, transmitting the task specifications for review by a plurality of human reviewers, receiving feedback responsive to the task specifications, and using the feedback to determine whether the potential annotation is a verified annotation. Some implementations are directed generally to determining an effectiveness measure for a task system and/or one or more reviewers, wherein the effectiveness measure is indicative of effectiveness in providing feedback instances related to one or more annotations for one or more textual segments.

### BACKGROUND

Computer-based textual annotators may be configured to identify and annotate various types of information in segments of text. For example, annotators may include a part of speech tagger configured to annotate terms with their parts of speech such as “noun”, “verb”, and “adjective”. As another example, annotators may be configured to disambiguate words that have multiple meanings, such as selecting the appropriate meaning for the word “bat” in a textual segment (i.e., selecting between the animal, the club used for hitting a ball, to wink briefly, etc.). As yet another example, some annotators may be configured to annotate information in a large segment of text such as a paragraph, multiple paragraphs, or an entire document. For instance, some annotators may annotate an emotional tone or a reading level of an entire document.

### SUMMARY

This specification is generally directed to determining and/or verifying annotations of textual segments based on electronically received human feedback that is responsive to questions generated to solicit feedback relevant to the annotations. In some implementations, verified annotations may be stored as “golden” data that can be utilized for various purposes such as evaluation and training. For example, verified annotations may be utilized as a baseline against which automated textual annotation systems are evaluated and/or against which human feedback related to annotations is evaluated. Also, for example, verified annotations may be utilized as training data in training a textual annotator to determine one or more annotations.

Some implementations are directed to generating one or more task specifications to solicit feedback relevant to a potential annotation of a target textual segment, transmitting the task specifications for review by a plurality of human reviewers, receiving feedback responsive to the task specifications, and using the feedback to determine whether the potential annotation is a verified annotation. In some implementations, the one or more task specifications may include at least first and second task specifications that are distinct from one another. For example, the first task specification may include a first question and first feedback options configured to solicit feedback relevant to the potential annotation and the second task specification may include a distinct second question and/or distinct second feedback options configured to solicit feedback relevant to the potential annotation. In some implementations, one or more task specifications generated for a potential annotation of a target textual segment may be provided to multiple distinct task systems such as MECHANICAL TURK, reCAPTCHA, a system for employees with expertise in linguistics, a system for vendors with expertise in linguistics, etc. For example, a first task specification may be provided to a first task system and the first task specification may also be provided to a second task system. In some implementations, one or more task specifications generated for a potential annotation may be provided to human reviewers having distinct attributes such as distinct locations, experiences, education, effectiveness measures (described below), etc.

Some implementations are directed generally to determining an effectiveness measure for a task system and/or one or more reviewers, wherein the effectiveness measure is indicative of effectiveness in providing feedback instances related to one or more annotations for one or more textual segments. In some implementations, the effectiveness measure may be based on a determined accuracy measure that indicates how often the feedback instances are correct and further based on one or more investment measures associated with the feedback instances. The investment measures for a feedback instance may include one or more of: a latency measure indicative of turnaround time in providing the feedback instance; a monetary measure indicative of cost associated with the feedback instance; and an overhead measure indicative of investment in generating a task specification to which the feedback instance is responsive. A determined effectiveness measure may be assigned to the task system and/or the one or more reviewers (e.g., the specific reviewers or attribute(s) of the reviewers). The assigned effectiveness measure may be utilized for various purposes such as determining whether to select the associated system and/or reviewers for one or more future annotation tasks, scoring future feedback instances provided by the system and/or reviewers, etc. In some implementations, the effectiveness measure may be determined based on feedback instances for annotations that are of a particular type and/or for task specifications that share one or more task specification properties, and a determined effectiveness measure may further be assigned to the particular type and/or the task specification properties. For example, a task system may have a first effectiveness measure for a first annotation type (e.g., co-reference) and a distinct second effectiveness measure for a second annotation type (e.g., entity type).

In some implementations, a computer implemented method may be provided that includes: identifying a target textual segment of an electronic resource; identifying a context textual segment for the target textual segment, the context textual segment including at least the textual segment; generating, by one or more processors, a first task specification based on the target textual segment and the context textual segment, the first task specification including a first question and one or more first feedback options to solicit feedback relevant to a potential annotation of the target textual segment; generating, by one or more of the processors, a second task specification based on the target annotation and the context textual segment, the second task specification including a second question and one or more second feedback options to solicit feedback relevant to the potential annotation of the target textual segment; wherein the first task specification is distinct from the second task specification; transmitting electronically the first task specification and the second task specification for feedback from a plurality of reviewers; in response to the transmitting, receiving first feedback for the first task specification and second feedback for the second task specification; determining, by one or more of the processors, the potential annotation is a verified annotation based on both the first feedback and the second feedback; and assigning, in one or more databases, the verified annotation to the target textual segment of the electronic resource.

This method and other implementations of technology disclosed herein may each optionally include one or more of the following features.

In some implementations, the method may further include: selecting, by one or more of the processors, a first task instance for the first task specification, the first task instance defining at least one of: one or more task systems and one or more of the reviewers; selecting, by one or more of the processors, a second task instance for the second task specification, the second task instance defining at least one of: the one or more task systems and the one or more of the reviewers; wherein the first task instance is distinct from the second task instance; and wherein transmitting the first task specification and the second task specification comprises transmitting the first task specification in accordance with the first task instance and transmitting the second task specification in accordance with the second task instance. In some of those implementations, the first task instance defines a first task system of the one or more task systems and the second task instance defines a distinct second task system of the one or more task systems. In some of those implementations, the first task instance defines first properties of the one or more reviewers and the second task instance defines distinct second properties of the one or more reviewers.

In some implementations, the potential annotation is a single annotation and the first task question and the second task question are each generated to verify the single annotation.

In some implementations, the potential annotation is one of a plurality of potential annotations for the target textual segment and at least one of the first task question and the second task question is generated to solicit feedback related to other of the potential annotations. In some of those implementations, the method further includes: identifying, by one or more of the processors, annotations of the context textual segment; and determining the potential annotations based on one or more of the annotations.

In some implementations, the method may further include: identifying, by one or more of the processors, one or more annotations of the context textual segment; and generating the first task specification may further be based on the annotations for the context textual segment. In some of those implementations, generating the first task specification based on the annotations for the context textual segment includes: selecting, from the context textual segment, one or more of the first feedback options based on the annotations associated with the first feedback options in the context textual segment. In some of those implementations, the annotations include annotations indicative of one or more entity types and generating the first task specification based on the annotations of the context textual segment includes: selecting, from the context textual segment, one or more of the first feedback options based on the one or more entity types associated with the first feedback options in the context textual segment. In some of those implementations, generating the first task specification based on the annotations for the context textual segment includes: generating the first question based on the annotations.

In some implementations, generating the first task specification comprises: identifying a task specification template that defines a target textual segment wildcard and a context textual segment wildcard; and generating the first task specification by incorporating the target textual segment as the target textual segment wildcard and the context textual segment as the context textual segment wildcard. In some of those implementations, the task specification template further defines a potential annotation wildcard and generating the first task specification further comprises: generating the first task specification by incorporating text corresponding to the potential annotation as the potential annotation wildcard.

In some implementations, the method further includes training a textual annotator to determine the potential annotation based on training data that includes the target textual segment with the assigned verified annotation.

In some implementations, determining the potential annotation is a verified annotation based on both the first feedback and the second feedback comprises: determining the potential annotation is a verified annotation based on a quantity of feedback instances of the first feedback and the second feedback that indicate the potential annotation is correct.

In some implementations, determining the potential annotation is a verified annotation based on both the first feedback and the second feedback comprises: identifying feedback instances of the first feedback and the second feedback that indicate the potential annotation is correct; identifying a measure associated with each of the identified instances; and determining the potential annotation is a verified annotation based on a quantity of the instances and based on the measures. In some of those implementations, the measures are effectiveness measures determined based on accuracy measures associated with the reviewers that provided the feedback instances.

In some implementations, a computer implemented method may be provided that includes: receiving feedback instances of one or more users of one or more task systems, the feedback instances related to one or more annotations for one or more textual segments; associating each of the feedback instances with one or more investment measures, the investment measures for each of the feedback instances comprising one or more of: a latency measure indicative of turnaround time in providing the feedback instance, a monetary measure indicative of cost associated with the feedback instance, and an overhead measure indicative of investment in generating a task specification to which the feedback instance is responsive; calculating, by one or more processors, one or more accuracy measures for the feedback instances based on comparing the feedback instances to verified data for the one or more annotations; and calculating, by one or more of the processors, an effectiveness measure for at least one of: the one or more users and the task system, wherein calculating the effectiveness measure comprises calculating the effectiveness measure based on the one or more accuracy measures for the feedback instances and the one or more investment measures for the feedback instances; and assigning, in one or more databases, the effectiveness measure to the at least one of: the one or more users and the task system.

This method and other implementations of technology disclosed herein may each optionally include one or more of the following features.

In some implementations, the investment measures comprise the latency measure and the monetary measure.

In some implementations, the investment measures comprise the latency measure, the monetary measure, and the overhead measure.

In some implementations, the one or more annotations are all associated with a particular annotation type, and assigning the effectiveness measure to the at least one of: the one or more users and the task system comprises: assigning the effectiveness measure to the particular annotation type and to the at least one of: the one or more users and the task system.

In some implementations, the task specifications to which the feedback instances are responsive are all associated with a set of one or more task specification properties, and assigning the effectiveness measure to the at least one of: the one or more users and the task system comprises: assigning the effectiveness measure to the set of the one or more task specification properties and to the at least one of: the one or more users and the task system.

In some implementations, the effectiveness measure is assigned to a task system of the task systems and the method further comprises: generating a new task specification related to an annotation for a textual segment; providing the new task specification to the task system; receiving one or more new feedback instances responsive to the providing; and scoring the new feedback instances based at least in part on the effectiveness measure.

In some implementations, the effectiveness measure is assigned to the one or more users and the method further comprises: generating a new task specification related to an annotation for a textual segment; providing the new task specification to the one or more users; receiving one or more new feedback instances responsive to the providing; and scoring the new feedback instances based at least in part on the effectiveness measure.

In some implementations, associating each of the feedback instances with one or more investment measures comprises collectively associating all of the feedback instances with the one or more investment measures.

In some implementations, a computer implemented method may be provided that includes: identifying a target textual segment of an electronic resource; identifying a context textual segment for the target textual segment, the context textual segment including at least the textual segment; generating, by one or more processors, a task specification based on the target textual segment and the context textual segment, the task specification including a question and one or more feedback options to solicit feedback relevant to a potential annotation of the target textual segment; transmitting electronically the task specification for feedback from a plurality of reviewers; in response to the transmitting, receiving feedback for the task specification; determining, by one or more of the processors, the potential annotation is a verified annotation based on the feedback; and assigning, in one or more databases, the verified annotation to the target textual segment of the electronic resource.

Other implementations may include a non-transitory computer readable storage medium storing instructions executable by a processor to perform a method such as one or more of the methods described above. Yet another implementation may include a system including memory and one or more processors operable to execute instructions, stored in the memory, to perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example environment in which annotations of textual segments may be verified and/or effectiveness measures for task systems and/or reviewers may be determined.

FIG. 2 illustrates an example of generating task specifications to solicit feedback relevant to potential annotations of textual segments of a resource, transmitting the task specifications for review by human reviewers, and using feedback from the reviewers to determine whether the potential annotations are verified annotations.

FIG. 3A illustrates an example graphical user interface for displaying a first example task specification to a human reviewer.

FIG. 3B illustrates an example graphical user interface for displaying a second example task specification to a human reviewer.

FIG. 3C illustrates an example graphical user interface for displaying a third example task specification to a human reviewer.

FIG. 3D illustrates an example graphical user interface for displaying a fourth example task specification to a human reviewer.

FIG. 4 illustrates an example of providing the example first and second task specifications of FIGS. 3A and 3B to a plurality of human reviewers via a first task system; and providing the example first task specification of FIG. 3A to a plurality of human reviewers via a second task system; and using feedback from the reviewers to determine whether a potential annotation for which the task specifications are configured is a verified annotation.

FIG. 5 is a flow chart illustrating an example method of verifying an annotation of a textual segment based on reviewer feedback.

FIG. 6 is a flow chart illustrating an example method of determining an effectiveness measure for a task system and/or reviewers.

FIG. 7 illustrates an example architecture of a computer system.

### DETAILED DESCRIPTION

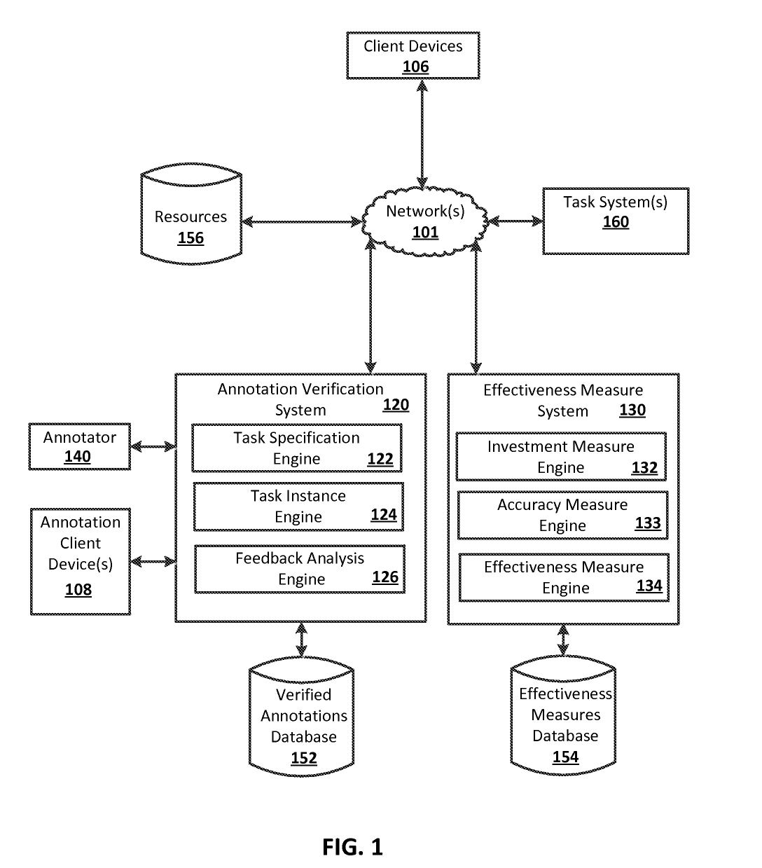

FIG. 1 illustrates an example environment in which annotations of textual segments may be verified and/or effectiveness measures for task systems and/or reviewers may be determined. As used herein, an annotation is an information item associated with one or more textual segments and provides syntactic and/or semantic information about the textual segments that is in addition to the characters of the textual segments alone. Annotations may apply to various sizes of textual segments such as a single term, multiple terms (continuous or discontinuous), a phrase, a sentence, a paragraph, an entire resource, and so forth. Some examples of annotations that may be applied to one or more terms include a part of speech (e.g., noun, verb, adjective, adverb), a word sense, an entity type (e.g., location, person, organization, other), dependency information (e.g., which terms modify and/or are modified by a given term; whether a term is a subject, verb, etc. of a sentence), subjectivity/objectivity, and co-reference resolution of the term(s) to one or more entities. Some examples of annotations that may be applied to larger textual segments (e.g., sentences, paragraphs, documents) include emotional tone, sarcasm/lack of sarcasm, reading level, author intent, prominent characters, prominent locations, prominent events, and/or subjectivity/objectivity. Techniques described herein may be utilized to determine and/or verify one or more of these and/or other annotations and/or to determine effectiveness measures for task systems and/or reviewers that are relevant to these and/or other annotations.

The example environment of FIG. 1 includes an annotation verification system 120, an effectiveness measure system 130, an annotator 140, one or more annotation client devices 108, one or more task systems 160, and client devices 106. The example environment also includes resources database 156, a verified annotations database 152, and an effectiveness measures database 154. The annotation verification system 120, the effectiveness measure system 130, and other components of the example environment may be implemented in one or more computers that communicate, for example, through one or more networks such as networks 101. Networks 101 may include one or more local area networks (LANs) or wide area networks (WANs) (e.g., the Internet)

The annotation verification system 120 and the effectiveness measure system 130 are example apparatus in which the systems, components, and techniques described herein may be implemented and/or with which systems, components, and techniques described herein may interface. One or more components of the annotation verification system 120, the effectiveness measure system 130, the annotator 140, and/or the task systems 160 may be incorporated in a single system in some implementations.

Generally, annotation verification system 120 generates one or more task specifications to solicit feedback relevant to a potential annotation of a textual segment, transmits the task specifications for review by a plurality of human reviewers, receives feedback responsive to the task specifications, and uses the feedback to determine whether the potential annotation is a verified annotation. In various implementations, annotation verification system 120 may include a task specification engine 122, a task instance engine 124, and/or a feedback analysis engine 126. In some implementations, all or aspects of engines 122, 124, and/or 126 may be omitted. In some implementations, all or aspects of engines 122, 124, and/or 126 may be combined. In some implementations, all or aspects of engines 122, 124, and/or 126 may be implemented in a component that is separate from annotation verification system 120.

Generally, task specification engine 122 generates task specifications to solicit feedback relevant to potential annotations of textual segments. In some implementations, the task specification engine 122 generates a task specification for a target textual segment based on the target textual segment itself, based on a context textual segment that includes at least the target textual segment, and based on one or more potential annotations for the target textual segment. A target textual segment includes one or more terms for which an annotation is to be determined and/or verified. A context textual segment includes at least the target textual segment, and optionally one or more additional terms to provide context.

A task specification generated by the task specification engine 122 includes at least one question and one or more feedback options to solicit feedback relevant to one or more of the potential annotations. As used herein, a “question” includes textual segments that include one or more interrogative terms such as “what”, “which”, and “who”; and also includes textual segments that may fail to include any interrogative term, but that elicit some response on the part of a reader. For example, the sentence “Please select the definition that most closely conforms to “bat” as it is used in the preceding passage” constitutes a question as used herein since it elicits selection by the user of one of multiple feedback options.

As one example of generating a task specification, consider the sentence: “Zohan's favorite Louisville attractions are the track and the NuLu shops and restaurants.” “The track” may be the target textual segment and the entire sentence may be the context textual segment. Moreover, it may be desirable to determine an entity type for “the track” and the potential annotations for an entity type may include “person”, “location”, “organization”, and “other”. Task specification engine 122 may generate one or more task specifications to solicit feedback relevant to one or more of the potential annotations. For example, task specification engine 122 may generate a task specification that includes: a question of “Does ‘the track’ underlined in the following sentence refer to a location”; a reproduction of the sentence with “the track” underlined; and yes and no feedback options. Also, for example, task specification engine 122 may generate a task specification that includes: a reproduction of the sentence; a question of “Select all of the following that refer to locations in the preceding sentence”; and feedback options of “Zohan”, “Louisville”, “the track”, and “Nulu”.

As another example of generating a task specification, consider again the sentence: “Zohan's favorite Louisville attractions are the track and the NuLu shops and restaurants.” The entire sentence may be both the target textual segment and the context textual segment. Moreover, it may be desirable to determine author intent for the sentence and the potential annotations for the author intent may include “persuade” and “inform”. Task specification engine 122 may generate one or more task specifications to solicit feedback relevant to one or more of the potential annotations. For example, task specification engine 122 may generate a task specification that includes: a reproduction of the sentence; a question of “Do you agree that the purpose of the preceding sentence is to inform the reader”; and feedback options of “strongly disagree”, “disagree”, “agree”, and “strongly agree”. Also, for example, task specification engine 122 may generate a task specification that includes: a reproduction of the sentence; a question of “Is the preceding sentence informative or persuasive”; and feedback options of “informative” and “persuasive”.

In some implementations, one or more of a target textual segment, a context textual segment, and a potential annotation may be identified based at least in part on user input from one or more annotation client devices 108 in communication with the annotation verification system 120. For example, a user may select a target textual segment and a context textual segment in a resource such as a resource from resources database 156. For example, the target textual segment may be identified based on the user highlighting or otherwise flagging the textual segment via a graphical user interface that presents at least a portion of the resource. As referred to herein, a “selection” by a user may include, for example a mouse-click, a click-through, a voice-based selection, a selection by a user's finger on a presence-sensitive input mechanism (e.g., a touch-screen device), and/or any other appropriate selection mechanism. As referred to herein, resources include web pages, word processing documents, portable document format (“PDF”) documents, emails, SMS/text messages, feed sources, calendar entries, to name just a few.

As another example, a user may select one or more potential annotations for a textual segment by providing input via one of the annotation client devices 108. For instance, the user may select a single potential annotation such as a particular entity type, or may identify a plurality of potential annotations such as entity type in general. Also, for instance, the user may select a single potential emotional tone for a textual segment, or may select a plurality of potential emotional tones. In some implementations, the user may rely on one or more annotations provided by annotator 140 as the potential annotations. For example, the annotator 140 may be configured to identify and annotate various types of information in textual segments, may annotate a particular term as a “location” entity, and the user may select such annotation as the potential annotation.

In some implementations, the task specification engine 122 may automatically identify one or more of a target textual segment, a context textual segment, and a potential annotation. In some of those implementations, the task specification engine 122 may identify one or more of those items based on annotations provided by annotator 140. For example, a target textual segment and a potential annotation may be identified based on the target textual segment having a certain type of annotation (to verify the annotation) or may be identified based on the target textual segment failing to have a certain type of annotation (to determine and verify the annotation). Also, for example, where a target textual segment is a term, the task specification engine 122 may select the sentence in which the term is included as the context textual segment, and optionally one or more sentences preceding or following the sentence. Also, for example, the task specification engine 122 may select a context textual segment based on the potential annotation. For example, the task specification engine 122 may select a longer context textual segment when determining and/or verifying a co-reference resolution annotation than when determining and/or verifying an entity mention annotation.

The task specification engine 122 may employ various techniques to generate task specifications. For example, annotations provided by annotator 140 for a context textual segment may be utilized to determine a task specification. For example, consider the example task specification above that includes: a question of “Does ‘the track’ underlined in the following sentence refer to a location”; a reproduction of the sentence with “the track” underlined; and yes and no feedback options. An existing annotation for “the track” may indicate an entity type of “location” (optionally with one or more other potential entity types such as “object”), and the task specification engine 122 may utilize such existing annotation to generate the question of the task specification (e.g., to include “location” in the question). Also, for example, consider the example task specification above that includes: a reproduction of the sentence; a question of “Select all of the following that refer to locations in the preceding sentence”; and feedback options of “Zohan”, “Louisville”, “the track”, and “Nulu”. One or more terms such as “Louisville”, “Zohan”, and “Nulu” may be selected from the context textual segment as potential feedback options based on those terms being annotated by the annotator 140 as entity mentions.

As another example, the task specification engine 122 may utilize one or more task specification templates in generating task specifications. For example, a task specification template may define a target textual segment wildcard, a context textual segment wildcard, and/or a potential annotation wildcard, and a task specification may be generated by incorporating the target textual segment, the context textual segment, and/or the potential annotations in the respective wildcards. For instance, consider again the example task specification above that includes: a question of “Does ‘the track’ underlined in the following sentence refer to a location”; a reproduction of the sentence with “the track” underlined; and yes and no feedback options template. The task specification engine 122 may generate the task specification based on a template that conforms to the following, with “[ ]” indicating a wildcard. “Does [target textual segment] in the following sentence refer to a [potential annotation]? YES NO [context textual segment with target textual annotation underlined]. Such a template may be specific to entity type task specifications. Other templates may be utilized and may optionally be specific to one or more types of annotations.

As described in more detail herein, in some implementations the task specification engine 122 may generate multiple task specifications for a potential annotation of a given target textual segment to solicit feedback relevant to the potential annotation of the given target textual segment. For example, for a given target textual segment at least first and second task specifications may be generated that are distinct from one another. For example, the first task specification may include a first question and first feedback options configured to solicit feedback relevant to a potential annotation and the second task specification may include a distinct second question and/or distinct second feedback options configured to solicit feedback relevant to the potential annotation.

Generally, task instance engine 124 selects task instances for generated task specifications. A task instance defines one or more task systems 160 and/or one or more reviewers to which the generated task specification is to be provided. The task systems 160 may include various task systems such as one or more crowd sourced Internet marketplaces (e.g. AMAZON'S MECHANICAL TURK, reCAPTCHA), a system for employees with expertise in linguistics, a system for vendors with expertise in linguistics, etc. Generally, each of the task systems 160 is configured to receive task specifications, provide those task specifications to client devices 106 of a plurality of reviewers, and receive feedback from the reviewers (via the client devices 106) that is responsive to the task specifications. The provided feedback may be provided to the feedback analysis engine 126 as described below. In some implementations, some or all of the aspects of one or more task systems 160 may be incorporated in annotation verification system 120.

The client devices 106 may include, for example, desktop computing devices, laptop computing devices, tablet computing devices, mobile phone computing devices, or wearable apparatus that include a computing device (e.g., a watch of the user having a computing device, glasses of the user having a computing device). Additional and/or alternative client devices may be provided. The client devices 106 typically include one or more applications to facilitate receiving of task specifications and providing of feedback in response to the task specifications, For example, the client devices 106 may execute one or more applications, such as a browser or stand-alone application, that allow users to receive task specification and provide feedback in response to the task specifications.

One or more of the task systems 160 may be configured to provide task specifications to certain reviewers based on task instances for the task specifications. For example, the task instance may define particular reviewers who are to receive a task specification and one of the task systems 160 may be configured to provide the task specification to those particular reviewers. Also, for example, the task instance may define one or more properties of reviewers who are to receive a task specification and one of the task systems 160 may be configured to provide the task specification to reviewers having those properties. Properties of a reviewer may include, for example, location(s) associated with the reviewer, past reviewing experiences associated with the reviewer, educational attributes associated with the reviewer, accuracy measures associated with the reviewer, etc.

As described in more detail herein, in some implementations one or more task specifications generated for a potential annotation of a given target textual segment may be provided to distinct task systems and/or to distinct reviewers. For example, a first task specification may be provided to a first task system and the first task specification may also be provided to a second task system. Also for example, one or more task specifications generated for a potential annotation of a given target textual segment may be provided to a first set of human reviewers having first attributes and may also be provided to a second set of human reviewers having distinct second attributes.

Generally, feedback analysis engine 126 uses the reviewer feedback provided for task specifications to determine whether potential annotations are verified annotations. For example, one or more task specifications generated for a potential annotation of a given target textual segment may be provided to fifty distinct reviewers via one or more task systems 160, and feedback may be received from each of the fifty reviewers. The feedback analysis engine 126 may determine whether the potential annotation is a verified annotation based on the feedback. For example, the potential annotation may be determined to be a verified annotation based on a quantity of instances of the reviewer feedback that indicate the potential annotation is correct. For example, if at least a threshold number and/or frequency (e.g., 60%, 70%, 80%, or other percentage) of instances indicate the potential annotation is correct, it may be determined to be a verified annotation. The threshold number or frequency may be fixed, adjustable, and/or based on other factors. For example, in some implementations the threshold number may be dependent on the number of feedback instances and/or dependent on user input via one of the annotation client devices 108. Also, for example, in some implementations the threshold number may be dependent on feedback instances that indicate other potential annotations are correct. For instance, the potential annotation may be determined to be verified based on the quantity of instances of feedback indicating the potential annotation is correct more than the quantity of instances of feedback indicating other potential annotations are correct.

Additional and/or alternative considerations may be taken into account in determining a potential annotation is a verified annotation. For example, an accuracy measure (e.g., as described below) associated with each of the instances that indicate the potential annotation is correct may be taken into account in addition to a quantity of such instances. For example, instances of reviewer feedback may be weighted based on accuracy or other measures associated with the reviewers providing the reviewer feedback. Also, for example, where multiple weightings are provided as a feedback option (e.g., “strongly disagree”, “disagree”, “agree”, “strongly agree”), the selected weightings may be taken into account in determining a potential annotation is a verified annotation. For instance, ten occurrences of “agree” may be given less weight in determining a potential annotation is a verified annotation than ten occurrences of “strongly agree”.

When an annotation is determined to be a verified annotation, the verified annotation may be assigned to the target textual assignment in one or more databases such as verified annotations database 152. In some implementations, the verified annotations database 152 may store annotations and may map stored annotations to textual segments in respective resources stored in one or more other databases. In some implementations, the verified annotations database 152 may store both the annotations and the respective resources. For example, the verified annotations database 152 may store resources that have been modified to include respective annotations.

In some implementations, verified annotations may be utilized as “golden” data for various purposes such as evaluation and training. For example, verified annotations may be utilized as a baseline against which automated annotators are evaluated and/or against which human feedback related to annotations is evaluated (e.g., as described herein with respect to the effectiveness measure system 130). Also, for example, verified annotations may be utilized as training data in supervised or semi-supervised training of an annotator to determine one or more annotations.

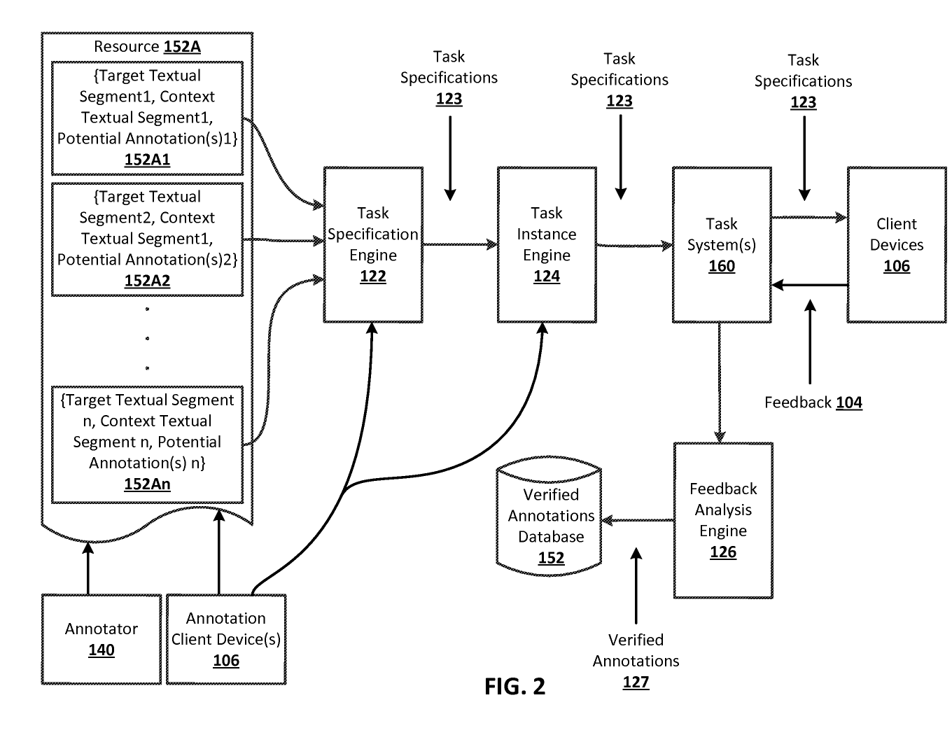

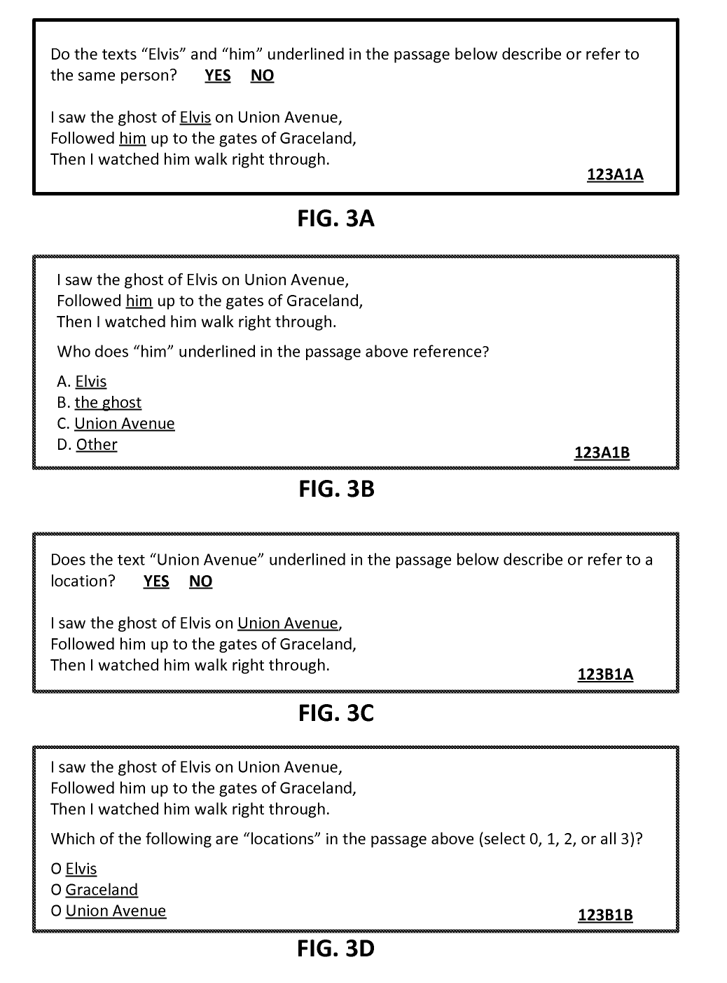

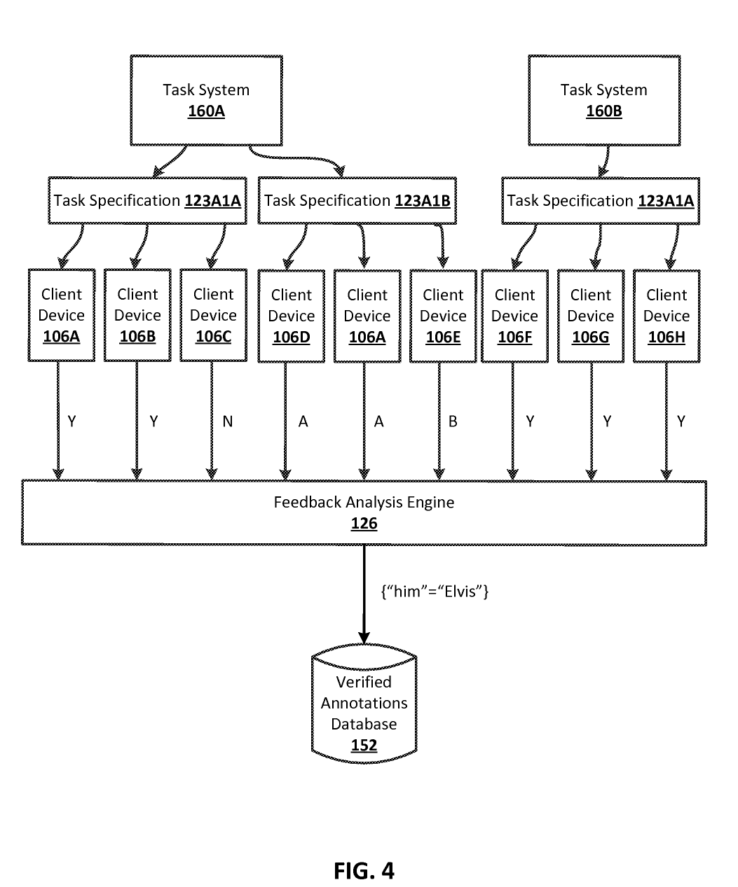

Referring now to FIG. 2, further description is provided of aspects of generating task specifications to solicit feedback relevant to potential annotations of textual segments of a resource, transmitting the task specifications for review by human reviewers, and using feedback from the reviewers to determine whether the potential annotations are verified annotations. To aid in explaining the example of FIG. 2, reference will also be made to FIGS. 3A-3D and FIGS. 4.

Resource 152A may be identified from resources database 156 and/or other database. The resource 152A is annotated with first task specification parameters 152A1 that define a first target textual segment, a first context textual segment, and one or more first potential annotations. The resource 152A is also annotated with second task specification parameters 152A2 that define a second target textual segment, the first context textual segment, and one or more second potential annotations. The resource may also include additional task specification parameters generally indicated by the ellipsis and the task specification parameters 152An. The additional task specification parameters may include target textual segments, context textual segments, and/or potential annotations that are distinct from those of task specification parameters 152A1 and 152A2.

As described herein, in some implementations, one or more of a target textual segment, a context textual segment, and a potential annotation of the task specification parameters 152A1, 152A2, and/or 152An may be identified based at least in part on user input from one or more annotation client devices 108. For example, a target textual segment may be identified based on the user highlighting or otherwise flagging the textual segment via a graphical user interface that presents at least a portion of the resource. As another example, a user may select one or more potential annotations for a textual segment by providing input via one of the annotation client devices 108. As also described herein, in some implementations the user may rely on annotations of the resource 152A provided by annotator 140 in selecting one or more of the task specification parameters. Also, in some implementations, the task specification engine 122 may automatically identify one or more of the task specification parameters based on annotations of the resource 152A provided by annotator 140.

As one example, the resource 152A may be a webpage or other resource that includes the lyrics of the song “Walking in Memphis” and the first context textual segment of task specification parameters 152A1 and 152A2 may be the following:

I saw the ghost of Elvis on Union Avenue,

Followed him up to the gates of Graceland,

Then I watched him walk right through.

The first target textual segment of the first task specification parameters 152A1 may include the first occurrence of the word “him” in the example first context textual segment above and the potential annotation may be one or more co-reference resolutions of the term “him” (e.g., does “him” refer to “Elvis” or “ghost”). The one or more potential annotations in the first task specification parameters 152A1 may be defined specifically (e.g., one or more of “ghost” or “Elvis”), or the potential annotations may be defined generally as a potential annotation type (i.e., co-reference resolution). The second target textual segment of the second task specification parameters 152A2 may include the term “Union Avenue” in the example textual segment above and the potential annotation may be one or more potential entity types of the term “Union Avenue” (e.g., does “Union Avenue” refer to a “location”). The one or more potential annotations in the second task specification parameters 152A2 may be defined specifically (e.g., “location”), or the potential annotations may be defined generally as a potential annotation type (i.e., an entity type).

The task specification engine 122 identifies the first task specification parameters 152A1 and generates one or more of the task specifications 123 to solicit feedback relevant to the one or more potential annotations. For example, and continuing with the preceding example, the task specification engine 122 may generate the example task specification 123A1A of FIG. 3A and the example task specification 123A1B of FIG. 3B based on the first task specification parameters 152A1. For instance, potential co-reference resolution annotations for “him” in the example textual segment above may include “ghost”, “Elvis”, and/or “Union Avenue”. The task specification 123A1A of FIG. 3A may be generated to solicit feedback relative to the “Elvis” potential annotation. The task specification 123A1B of FIG. 3B may be generated to solicit feedback relative to the “Elvis” potential annotation and other potential annotations (i.e., the ghost, Union Avenue).

The task specification engine 122 also identifies the second task specification parameters 152A2 and generates one or more of the task specifications 123 to solicit feedback relevant to the one or more potential annotations. For example, and again continuing with the preceding example, the task specification engine 122 may generate the example task specification 123B1A of FIG. 3C and the example task specification 123B1B of FIG. 3D based on the second task specification parameters 152A2. For instance, potential annotations for “Union Avenue” in the example textual segment above may include “location”, “person”, “organization”, and “other”. The task specification 123B1A of FIG. 3C may be generated to solicit feedback relative to the “location” potential annotation. The task specification 123B1B of FIG. 3D may also be generated to solicit feedback relative to the “location” potential annotation. The task specification engine 122 may also identify additional task specification parameters of the resource 152A and generate one or more of the task specifications 123 based on such additional task specification parameters.

As described herein, the task specification engine 122 may employ various techniques to generate task specifications. For example, automatically generated annotations for the context textual segment may be utilized to determine the potential annotations. For example, for the “YES/NO” task specification 123A1A of FIG. 3A, an existing annotation for “him” may indicate a co-reference to “Elvis”, and such existing annotation may be utilized to generate the question of the task specification. Also, for example, for the “A/B/C/D” task specification 123A1B of FIG. 3B, terms (Elvis, the ghost, Union Avenue) may be selected from the context textual segment as potential feedback options based on those terms being annotated as entity mentions and occurring before the target textual segment.

As another example, a task specification template may be identified that defines a target textual segment wildcard, a context textual segment wildcard, and/or a potential annotation wildcard, and the task specification may be generated by incorporating the target textual segment, the context textual segment, and/or the potential annotations in the respective wildcards. For instance, a template for the “YES/NO” task specification 123A1A of FIG. 3A may conform to the following, with “[ ]” indicating a wildcard. “Do the texts [potential annotation] and [target textual segment] underlined in the passage below refer to the same person? YES NO [context textual segment with potential annotation and target textual annotation underlined].

The task specification engine 122 provides the generated task specifications 123 to task instance engine 124. For each of the task specifications 123, task instance engine 124 selects one or more task instances that each defines one or more task systems 160 and/or one or more reviewers to which the generated task specification is to be provided. In some implementations, the task instance engine 124 selects task instances for a task specification based on properties of the task specification, the type of potential annotation, and/or one or more accuracy measures, investment measures, and/or effectiveness measures. For example, task specifications having certain properties may always be provided to certain of the task systems 160 and/or never provided to certain of other task systems 160. Also, for example, a user defined importance of the task specification may be utilized to select one or more of the task systems 160 and/or reviewers based on one or more accuracy measures, investment measures, and/or effectiveness measures. The task instance engine 124 may utilize the task instances in determining which task systems 160 receive which task specifications and/or may provide information related to the task instances to the task systems. For example, one or more of the task systems 160 may be configured to provide task specifications to certain reviewers based on task instance reviewer information provided by the task instance engine 124. For instance, the task instance may define one or more properties of reviewers who are to receive a task specification and one of the task systems 160 may be configured to provide the task specification to reviewers having those properties.

The task instance engine 124 transmits the task specifications 123 to one or more of the task systems 160 in accordance with the determined task instances. The one or more task systems 160 receive the task specifications, provide those task specifications to client devices 106 of a plurality of reviewers, and receive feedback 104 from the reviewers (via the client devices 106) that is responsive to the task specifications. The task systems 160 provide the feedback 104 to the feedback analysis engine 126, optionally after preprocessing of the feedback.

Feedback analysis engine 126 uses the reviewer feedback provided for task specifications to determine whether potential annotations are verified annotations 127. For example, a potential annotation may be determined to be a verified annotation based on a quantity of instances of the reviewer feedback that indicate the potential annotation is correct. Those annotations that are determined to be verified annotations 127 are assigned to the target textual assignment in one or more databases such as verified annotations database 152.

With reference to FIG. 4, an example is provided of providing the example task specifications 123A1A, 123A1B of FIGS. 3A and 3B to a plurality of human reviewers via a first task system 160A; providing the example task specification 123A1A of FIG. 3A to a plurality of human reviewers via a second task system 160B; and using feedback from the reviewers to determine whether a potential annotation for which the task specifications are configured is a verified annotation. For example, the task instance engine 124 may have defined task specification 123A1A is to be provided to task system 160A and to distinct task system 160B. Task instance engine 124 may have further defined one or more reviewers to which the task systems 160A and 160B are to provide the task specification 123A1A. The task instance engine 124 may have further defined task specification 123A1B is to be provided to task system 160A only and may have further defined one or more reviewers to which the task system 160A is to provide the task specification 123A1B.

The task system 160A may provide the task specification 123A1A to client devices 106A-106C based on those client devices being associated with the one or more reviewers (e.g., specific reviewers or properties of those reviewers) defined by the task instance engine 124. Likewise, the task system 160A may provide the task specification 123A1B to client devices 106D, 106A, and 106E based on those client devices being associated with the one or more reviewers defined by the task instance engine 124. Note the client device 106A is associated with a reviewer defined by the task engine 124 for both task specification 123A1A and task specification 123A1B. The task system 160B may provide the task specification 123A1A to client devices 106F-106H based on those client devices being associated with the one or more reviewers defined by the task instance engine 124.

Feedback from the client devices 106A-H is provided to feedback analysis engine 126. In some implementations, the feedback is provided directly to feedback analysis engine 126. In some implementations, the feedback is provided to feedback analysis engine 126 via the task systems 160A and 160B. The feedback instances from client devices 106A, 106B, 106F, 106G, and 106H that are responsive to task specification 123A1A each indicate selection of “Yes” (indicated by “Y” in FIG. 4), which based on the task specification 123A1A (FIG. 3A) indicates the potential annotation of “Elvis” for the target textual segment “him” is correct. The feedback instance from client device 106C that is responsive to task specification 123A1A indicates selection of “No” (indicated by “N” in FIG. 4), which based on the task specification 123A1A (FIG. 3A) indicates the potential annotation of “Elvis” for the target textual segment “him” is incorrect. The feedback instances from client devices 106A and 106D that are responsive to task specification 123A1B each indicate selection of “A” (indicated by “A” in FIG. 4), which based on the task specification 123A1B (FIG. 3B) indicates the potential annotation of “Elvis” for the target textual segment “him” is correct. The feedback instance from client device 106E that is responsive to task specification 123A1B indicates selection of “B” (indicated by “B” in FIG. 4), which based on the task specification 123A1B (FIG. 3B) indicates the potential annotation of “Elvis” for the target textual segment “him” is incorrect.

The feedback analysis engine 126 uses the reviewer feedback to determine whether the potential annotation of “Elvis” as a co-reference resolution for “him” is a verified annotation. For example, the feedback analysis engine 126 may determine the potential annotation is correct based on seven out of nine of the feedback instances (77.8%) indicating it is a correct annotation. For instance, 77.8% may satisfy a threshold such as 70% and the feedback analysis engine 126 may determine the potential annotation is correct based on 77.8% satisfying the threshold. The verified annotation of “Elvis” as a co-reference resolution for “him” is assigned to the target textual segment in database 152. Additional and/or alternative considerations may be taken into account in determining a potential annotation is a verified annotation. For example, an accuracy measure (e.g., as described below) associated with the task system 160B may be indicative of less accuracy than an accuracy measure associated with the task system 160A. Based on the less trustworthy accuracy measure, the feedback analysis engine 126 may weigh the feedback instances provided by the client devices 160F-H less heavily than the other feedback instances in determining whether the potential annotation of “Elvis” as a co-reference resolution for “him” is a verified annotation.

Referring again to FIG. 1, effectiveness measure system 130 generally determines effectiveness measures for task systems and/or reviewers. Each effectiveness measure is generally indicative of effectiveness in providing feedback instances related to one or more annotations for one or more textual segments. In various implementations, effectiveness measure system 130 may include an investment measure engine 132, an accuracy measure engine 134, and/or an effectiveness measure engine 136. In some implementations, all or aspects of engines 132, 134, and/or 136 may be omitted. In some implementations, all or aspects of engines 132, 134, and/or 136 may be combined. In some implementations, all or aspects of engines 132, 134, and/or 136 may be implemented in a component that is separate from effectiveness measure system 130.

For a set of feedback instances, investment measure engine 132 associates the set of instances with one or more investment measures. The set of feedback instances may be, for example, feedback instances that are all associated with one or more of: one or more of the same task systems of task systems 160, one or more same or similar reviewer attributes; one or more particular reviewers; one or more annotation types; one or more task specification properties (e.g., a template on which the task specification was generated, number of feedback options, type of feedback options); and/or other same or similar properties. The set of feedback instances may be identified by the effectiveness measure system 132 based on user or automatically defined parameters. For example, if it is desirable to determine an effectiveness measure for a particular task system overall, feedback instances from that task system may be included in the set without regard to other properties associated with the feedback instances. Also, for example, if it is desirable to determine an effectiveness measure for users of a particular task system, wherein the users have one or more particular properties, only feedback instances from that system and from the users having the particular properties may be included in the set. Also, for example, if it is desirable to determine an effectiveness measure for a particular task system in providing feedback instances related to particular entity type annotations, only feedback instances from that system and for those particular entity type annotations may be included in the set.

In some implementations, the investment measures may include a latency measure indicative of turnaround time in providing the feedback instance. For example, MECHANICAL TURK instances may have turnaround time of less than a day, whereas instances from a system for employees or vendors with expertise in linguistics may have a turnaround time of multiple days. The latency measure assigned to a particular feedback instance may be an actual feedback time for that instance, or an average or other statistical measure indicative of latencies for a plurality of feedback instances of that type.

In some implementations, the investment measures may include a monetary measure indicative of cost associated with the feedback instance. For example, MECHANICAL TURK instances may have a cost of only a few cents, whereas instances for a system for employees or vendors with expertise in linguistics may have greater associated costs. The monetary measure assigned to a particular feedback instance may be an actual cost for that instance, or an average or other statistical measure indicative of costs for a plurality of feedback instances of that type.

In some implementations, the investment measures may include an overhead measure indicative of investment in generating a task specification to which the feedback instance is responsive. For example, computational and/or employee overhead may be associated with generating the task specifications and may vary depending on the task specification and/or the system or users to which the task specifications are provided. For example, task specifications for MECHANICAL TURKS may require more employee and/or computational overhead than task specifications for linguistics trained employees or vendors (under the assumption the linguistics trained employees/vendors will need less guidance and/or may not need specifically formulated questions/feedback options). The overhead measure assigned to a particular feedback instance may be an actual measure for that instance, or an average or other statistical measure indicative of overhead measures for a plurality of feedback instances of that type.

In some implementations, the investment measure engine 132 may be in communication with the annotation verification system 120 and/or the task system(s) 160 and may receive input related to one or more of the investment measures from such systems.

For the set of feedback instances, accuracy measure engine 134 calculates an accuracy measure for the set. In some implementations, the accuracy measure for the feedback instances may be based on comparing the feedback instances to verified data for the one or more annotations (e.g., the verified “golden” data described with respect to annotation verification system 120 and/or other data). For example, the accuracy measure may be based on a frequency of correct annotations indicated by the feedback instances. For instance, 70% of the feedback instances may have correctly identified the annotations. As one example, provided feedback instances of a task system for multiple task specifications may be compared to “correct” feedback instances for those multiple task specifications to determine an accuracy measure of the feedback instances.

Effectiveness measure engine 136 calculates an effectiveness measure as a function of the determined accuracy measure and the one or more investment measures associated with the feedback instances. For example, an effectiveness measure for an accuracy measure of 70% with desirable investment measures may be more indicative of effectiveness than an effectiveness measure for an accuracy measure of 75% with undesirable investment measures. In some implementations, various weightings may be applied to the accuracy measure and/or one or more of the investment measures in determining the effectiveness measure. For example, the accuracy measure may be weighted greater than any of the investment measures. Also, for example, where multiple investment measures are utilized, the monetary measure may be weighted greater than other of the investment measures.

The effectiveness measure system 130 assigns the effectiveness measure to one or more features of the set of feedback instances, and stores the assigned effectiveness measure in the effectiveness measures database 154. For example, where the set of feedback instances are feedback instances associated with a particular task system and/or particular users, the effectiveness measure may be assigned to the task system and/or users. Also, for example, where the set of feedback instances are feedback instances associated with a particular task system and one or more annotation types and/or task specification properties, the effectiveness measure may be assigned to the task system and the annotation types and/or task specification properties. In other words, the effectiveness measure may be assigned to be indicative of effectiveness of the task system in providing feedback for the annotation types and/or task specification properties.

An effectiveness measure assigned to a task system and/or reviewers may be utilized for various purposes such as determining whether to select the associated task system and/or reviewers for one or more future annotation tasks, evaluating a task system and/or reviewers, scoring future feedback instances provided by the task system and/or reviewers, etc. As described above, in some implementations, the effectiveness measure may be determined for annotations that are of a particular type and/or for task specifications that share one or more task specification properties, and a determined effectiveness measure may further be assigned to the particular type and/or the task specification properties. For instance, a system may have a first effectiveness measure for a first annotation type (e.g., co-reference) and a distinct second effectiveness measure for a second annotation type (e.g., entity type).

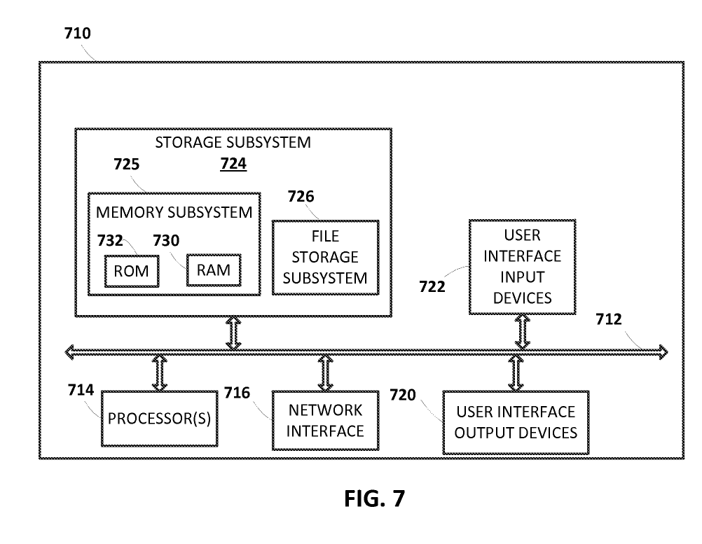

The components of the example environment of FIG. 1 may each include memory for storage of data and software applications, a processor for accessing data and executing applications, and components that facilitate communication over a network. In some implementations, such components may include hardware that shares one or more characteristics with the example computer system that is illustrated in FIG. 7. The operations performed by one or more components of the example environment may optionally be distributed across multiple computer systems. For example, the steps performed by the annotation verification system 120 and/or the effectiveness measure system 130 may be performed via one or more computer programs running on one or more servers in one or more locations that are coupled to each other through a network. In this specification, the term “database” will be used broadly to refer to any collection of data. The data of the database does not need to be structured in any particular way, or structured at all, and it can be stored on storage devices in one or more locations. Thus, for example, the database may include multiple collections of data, each of which may be organized and accessed differently.

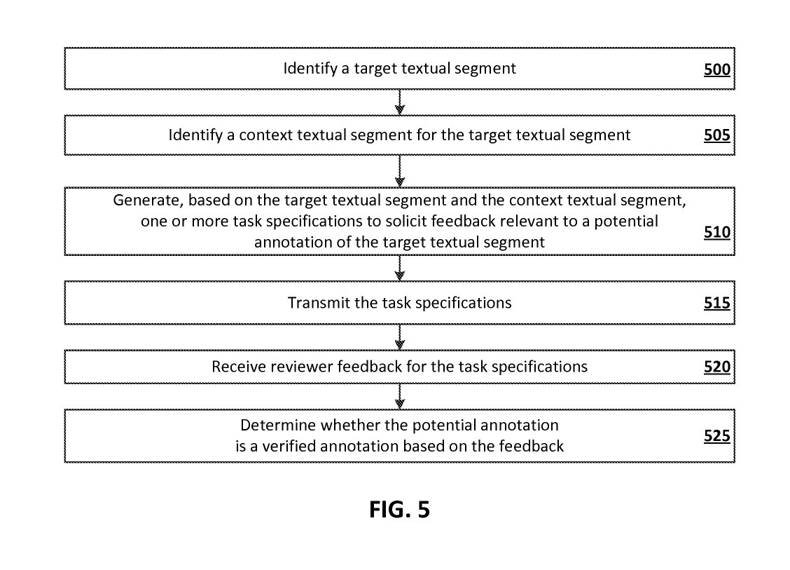

FIG. 5 is a flow chart illustrating an example method of verifying an annotation of a textual segment based on reviewer feedback. Other implementations may perform the steps in a different order, omit certain steps, and/or perform different and/or additional steps than those illustrated in FIG. 5. For convenience, aspects of FIG. 5 will be described with reference to a system of one or more computers that perform the process. The system may include, for example, one or more of the engines 122, 124, and 126 of annotation verification system 120.

At step 500, a target textual segment is identified. In some implementations, the system may identify the target textual segment based on a user selection of the target textual segment in a resource. In some implementations, the system may automatically identify the target textual segment based on annotations of the target textual segment provided by annotator 140. For example, a target textual segment may be identified based on the target textual segment having a certain type of annotation (to verify the annotation).

At step 505, a context textual segment is identified for the target textual segment. In some implementations, the system may identify the context textual segment based on a user selection of the context textual segment in a resource. In some implementations, the system may automatically identify the context textual segment. For example, for a user selected or automatically selected target textual segment that is a term, the system may select the sentence in which the term is included as the context textual segment, and optionally one or more sentences preceding or following the sentence.

At step 510, one or more task specifications are generated to solicit feedback relevant to a potential annotation of the target textual segment. In some implementations, the task specifications may be generated based on the target textual segment, the context textual segment, and/or the potential annotation. For example, one or more techniques described herein with respect to task specification engine 122 may be utilized to generate the one or more task specifications. In some implementations, the one or more task specifications may include at least first and second task specifications that are distinct from one another.

At step 515, the task specifications are transmitted. For example, the system may transmit the task specifications to one or more task systems 160 for providing of the task specifications to reviewers by the task systems 160. In some implementations, the system may directly transmit the task specifications to client devices of the reviewers. In some implementations, one or more of the task specifications may be provided to multiple distinct task systems 160. For example, a first task specification may be provided to a first task system and the first task specification may also be provided to a second task system. In some implementations, one or more of the task specifications may be provided to multiple sets of human reviewers, with each set having distinct attributes.

At step 520, reviewer feedback for the task specifications is received. For example, the system may receive the reviewer feedback from one or more of the task systems, or directly from client devices of the reviewers.

At step 525, it is determined whether the potential annotation is a verified annotation based on the feedback. For example, the system may determine whether the potential annotation is a verified annotation based a quantity of instances of the reviewer feedback that indicate the potential annotation is correct. For example, if at least a threshold number and/or frequency of instances indicate the potential annotation is correct, it may be determined to be a verified annotation. When an annotation is determined to be a verified annotation, the system may assign the verified annotation to the target textual assignment in one or more databases such as verified annotations database 152.

The steps of FIG. 5 may be repeated for one or more target textual segments, context textual segments, and potential annotations in a resource and/or multiple resources. For example, the steps of FIG. 5 may be repeated for one or more target textual segments, context textual segments, and potential annotations in multiple resources to develop a “golden” data set for evaluation and/or training purposes.

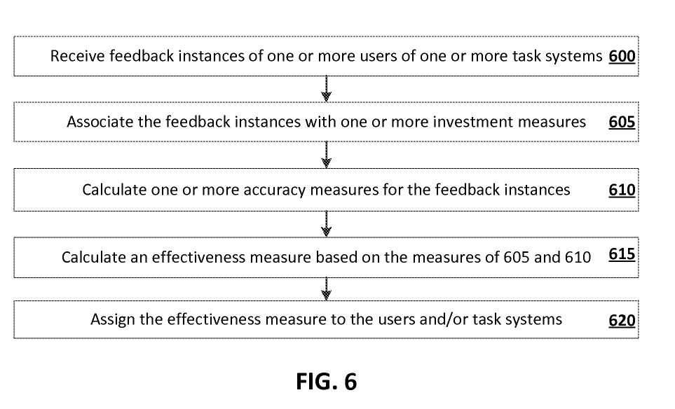

FIG. 6 is a flow chart illustrating an example method of determining an effectiveness measure for a task system and/or reviewers. Other implementations may perform the steps in a different order, omit certain steps, and/or perform different and/or additional steps than those illustrated in FIG. 6. For convenience, aspects of FIG. 6 will be described with reference to a system of one or more computers that perform the process. The system may include, for example, one or more of the engines 132, 134, and 136 of effectiveness measure system 130.

At step 600, feedback instances of one or more users of one or more task systems are received. The feedback instances may be, for example, feedback instances that are all associated with one or more of: one or more of the same task systems of task systems 160, one or more same or similar reviewer attributes; one or more particular reviewers; one or more annotation types; one or more task specification properties (e.g., a template on which the task specification was generated, number of feedback options, type of feedback options); and/or other same or similar properties. The set of feedback instances may be identified by the system based on user or automatically defined parameters.

At step 605, the feedback instances are associated with one or more investment measures such as a monetary measure, a latency measure, and an overhead measure.

At step 610, one or more accuracy measures are calculated for the feedback instances. In some implementations, the system may determine the accuracy measure for the feedback instances based on comparing the feedback instances to verified data for the one or more annotations for which the feedback instances are responsive. For example, the system may determine the accuracy measure based on a frequency of correct annotations indicated by the feedback instances.

At step 615, an effectiveness measure is calculated based on the one or more investment measures and the one or more accuracy measures. In some implementations, various weightings may be applied to the accuracy measure and/or one or more of the investment measures in determining the effectiveness measure.

At step 620, the effectiveness measure is assigned to the users and/or task systems. For example, where the set of feedback instances are feedback instances associated with a particular task system and/or particular users, the system may assign the effectiveness measure may be assigned to the task system and/or users in the effectiveness measures database 154. In some implementations, the effectiveness measure may be determined based on feedback instances for annotations that are of a particular type and/or for task specifications that share one or more task specification properties, and a determined effectiveness measure may further be assigned to the particular type and/or the task specification properties. For example, a task system may have a first effectiveness measure for a first annotation type (e.g., co-reference) and a distinct second effectiveness measure for a second annotation type (e.g., entity type).

FIG. 7 is a block diagram of an example computer system 710. Computer system 710 typically includes at least one processor 714 which communicates with a number of peripheral devices via bus subsystem 712. These peripheral devices may include a storage subsystem 724, including, for example, a memory subsystem 725 and a file storage subsystem 726, user interface input devices 722, user interface output devices 720, and a network interface subsystem 716. The input and output devices allow user interaction with computer system 710. Network interface subsystem 716 provides an interface to outside networks and is coupled to corresponding interface devices in other computer systems.

User interface input devices 722 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 710 to the user or to another machine or computer system.

Storage subsystem 724 stores programming and data constructs that provide the functionality of some or all of the modules described herein. For example, the storage subsystem 724 may include the logic to perform one or more of the methods described herein such as, for example, the methods of FIGS. 5 and/or 6.

These software modules are generally executed by processor 714 alone or in combination with other processors. Memory 725 used in the storage subsystem can include a number of memories including a main random access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored in the storage subsystem 724, or in other machines accessible by the processor(s) 714.

Bus subsystem 712 provides a mechanism for letting the various components and subsystems of computer system 710 communicate with each other as intended. Although bus subsystem 712 is shown schematically as a single bus, alternative implementations of the bus subsystem may use multiple busses.

Computer system 710 can be of varying types including a workstation, server, computing cluster, blade server, server farm, or any other data processing system or computing device. Due to the ever-changing nature of computers and networks, the description of computer system 710 depicted in FIG. 7 is intended only as a specific example for purposes of illustrating some implementations. Many other configurations of computer system 710 are possible having more or fewer components than the computer system depicted in FIG. 7.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A computer-implemented method, comprising:
identifying a target textual segment of an electronic resource;
identifying a context textual segment for the target textual segment, the context textual segment including at least the textual segment;
generating, by one or more processors, a first task specification based on the target textual segment and the context textual segment, the first task specification including a first question and one or more first feedback options to solicit feedback relevant to a potential annotation of the target textual segment;
generating, by one or more of the processors, a second task specification based on the same target textual segment and the same context textual segment, the second task specification including a second question and one or more second feedback options to solicit feedback relevant to the potential annotation of the target textual segment;
wherein the first task specification is distinct from the second task specification;
selecting, by one or more of the processors, a first task system for the first task specification,
wherein selecting the first task system is based on one or more properties of the first task specification and based on one or more accuracy measures of the first task system, and
wherein the one or more accuracy measures of the first task system are based on how often past feedback from the first task system is correct;
selecting, by one or more of the processors, a second task system for the second task specification, the second task system being distinct from the first task system,
wherein selecting the second task system is based on one or more properties of the second task specification and based on one or more accuracy measures of the second task system, and
wherein the one or more accuracy measures of the second task system are based on how often past feedback from the second task system is correct;
transmitting electronically the first task specification for feedback from first reviewers of the first task system based on selecting the first task system for the first task specification;
transmitting the second task specification for feedback from second reviewers of the second task system based on selecting the second task system for the second task specification;
in response to the transmitting, receiving first feedback for the first task specification and second feedback for the second task specification;
determining, by one or more of the processors, the potential annotation is a verified annotation based on both the first feedback from the first reviewers of the first task system and the second feedback from the second reviewers of the second task system;
assigning, in one or more databases, the verified annotation to the target textual segment of the electronic resource; and
in response to the assigning, utilizing the verified annotation as training data to train a textual annotator.

2-4. (canceled)

5. The method of claim 1, wherein the potential annotation is a single annotation and the first task question and the second task question are each generated to verify the single annotation.

6. The method of claim 1, wherein the potential annotation is one of a plurality of potential annotations for the target textual segment and wherein at least one of the first task question and the second task question is generated to solicit feedback related to other of the potential annotations.

7. The method of claim 6, further comprising:
identifying, by one or more of the processors, annotations of the context textual segment; and
determining the potential annotations based on one or more of the annotations.

8. The method of claim 1, further comprising:
identifying, by one or more of the processors, one or more annotations of the context textual segment;
wherein generating the first task specification is further based on the annotations for the context textual segment .

9. The method of claim 8, wherein generating the first task specification based on the annotations for the context textual segment includes:
selecting, from the context textual segment, one or more of the first feedback options based on the annotations associated with the first feedback options in the context textual segment.

10. The method of claim 8, wherein the annotations include annotations indicative of one or more entity types and wherein generating the first task specification based on the annotations of the context textual segment includes:
selecting, from the context textual segment, one or more of the first feedback options based on the one or more entity types associated with the first feedback options in the context textual segment.

11. The method of claim 8, wherein generating the first task specification based on the annotations for the context textual segment includes:
generating the first question based on the annotations.

12. The method of claim 1, wherein generating the first task specification comprises:
identifying a task specification template that defines a target textual segment wildcard and a context textual segment wildcard; and
generating the first task specification by incorporating the target textual segment as the target textual segment wildcard and the context textual segment as the context textual segment wildcard.

13. The method of claim 12, wherein the task specification template further defines a potential annotation wildcard and wherein generating the first task specification further comprises:
generating the first task specification by incorporating text corresponding to the potential annotation as the potential annotation wildcard.

14. The method of claim 1, further comprising:
training the textual annotator to determine the potential annotation based on the training data that includes the target textual segment with the assigned verified annotation.

15. The method of claim 1, wherein determining the potential annotation is a verified annotation based on both the first feedback and the second feedback comprises:
determining the potential annotation is a verified annotation based on a quantity of feedback instances of the first feedback and the second feedback that indicate the potential annotation is correct.

16. The method of claim 1, wherein determining the potential annotation is a verified annotation based on both the first feedback and the second feedback comprises:
identifying feedback instances of the first feedback and the second feedback that indicate the potential annotation is correct;
identifying a measure associated with each of the identified instances; and
determining the potential annotation is a verified annotation based on a quantity of the instances and based on the measures.

17. The method of claim 16, wherein the measures are effectiveness measures determined based on accuracy measures associated with the reviewers that provided the feedback instances.

18. A computer-implemented method, comprising:
receiving feedback instances of one or more users of one or more task systems, the feedback instances related to one or more annotations for one or more textual segments;
associating each of the feedback instances with one or more investment measures, the investment measures for each of the feedback instances comprising one or more of:
a latency measure indicative of turnaround time in providing the feedback instance,
a monetary measure indicative of cost associated with the feedback instance, and
an overhead measure indicative of investment in generating a task specification to which the feedback instance is responsive;
calculating, by one or more processors, one or more accuracy measures for the feedback instances based on comparing the feedback instances to verified data for the one or more annotations; and
calculating, by one or more of the processors, an effectiveness measure for at least one of: the one or more users and the task system, wherein calculating the effectiveness measure comprises calculating the effectiveness measure based on the one or more accuracy measures for the feedback instances and the one or more investment measures for the feedback instances; and
assigning, in one or more databases, the effectiveness measure to the at least one of: the one or more users and the task system.

19. The method of claim 18, wherein the investment measures comprise the latency measure and the monetary measure.

20. The method of claim 18, wherein the investment measures comprise the latency measure, the monetary measure, and the overhead measure.

21. The method of claim 18, wherein the one or more annotations are all associated with a particular annotation type, and wherein assigning the effectiveness measure to the at least one of: the one or more users and the task system comprises:
assigning the effectiveness measure to the particular annotation type and to the at least one of: the one or more users and the task system.

22. The method of claim 18, wherein the task specifications to which the feedback instances are responsive are all associated with a set of one or more task specification properties, and wherein assigning the effectiveness measure to the at least one of: the one or more users and the task system comprises:
assigning the effectiveness measure to the set of the one or more task specification properties and to the at least one of: the one or more users and the task system.

23. The method of claim 18, wherein the effectiveness measure is assigned to a task system of the task systems and further comprising:
generating a new task specification related to an annotation for a textual segment;
providing the new task specification to the task system;
receiving one or more new feedback instances responsive to the providing;
scoring the new feedback instances based at least in part on the effectiveness measure.

24. The method of claim 18, wherein the effectiveness measure is assigned to the one or more users and further comprising:
generating a new task specification related to an annotation for a textual segment;
providing the new task specification to the one or more users;
receiving one or more new feedback instances responsive to the providing; and
scoring the new feedback instances based at least in part on the effectiveness measure.

25. A system, comprising:
memory storing instructions;
one or more processors operable to execute the instructions stored in the memory;
wherein the instructions comprise instructions to:
identify a target textual segment of an electronic resource;
identify a context textual segment for the target textual segment, the context textual segment including at least the textual segment;
generate a first task specification based on the target textual segment and the context textual segment, the first task specification including a first question and one or more first feedback options to solicit feedback relevant to a potential annotation of the target textual segment;
generate a second task specification based on the same target textual segment and the same context textual segment, the second task specification including a second question and one or more second feedback options to solicit feedback relevant to the potential annotation of the target textual segment;
wherein the first task specification is distinct from the second task specification;
select a first task system for the first task specification,
wherein selecting the first task system is based on one or more properties of the first task specification and based on one or more accuracy measures of the first task system,
wherein the one or more accuracy measures of the first task system are based on how often past feedback from the first task system is correct, and
wherein the first task system is a given one of: mechanical turk, reCAPTCHA, a system for employees with expertise in linguistics, and a system for vendors with expertise in linguistics;
select a second task system for the second task specification,
wherein selecting the second task system is based on one or more properties of the second task specification and based on one or more accuracy measures of the second task system,
wherein the one or more accuracy measures of the second task system are based on how often past feedback from the second task system is correct, and
wherein the second task system is distinct from the first task system and not the given one of: the mechanical turk, the reCAPTCHA, the system for employees with expertise in linguistics, and the system for vendors with expertise in linguistics;
transmit the first task specification for feedback from first reviewers of the first task system based on selecting the first task system for the first task specification;
transmit the second task specification for feedback from second reviewers of the second task system based on selecting the second task system for the second task specification;
in response to the transmitting, receiving first feedback for the first task specification and second feedback for the second task specification;
determine, by one or more of the processors, the potential annotation is a verified annotation based on both the first feedback from the first reviewers of the first task system and the second feedback from the second reviewers of the second task system;
assign, in one or more databases, the verified annotation to the target textual segment of the electronic resource; and
in response to the assignment, utilize the verified annotation as training data to train a textual annotator.

26. The method of claim 1:
wherein the first task system is a given one of: a mechanical turk, reCAPTCHA, a system for employees with expertise in linguistics, and a system for vendors with expertise in linguistics, and
wherein the second task system is another given one of: the mechanical turk, the reCAPTCHA, the system for employees with expertise in linguistics, and the system for vendors with expertise in linguistics.

27. The method of claim 1:
wherein selecting the first task system further comprises:
determining the first task specification has a certain property of the one or properties, and
selecting the first task system for the first task specification based on the certain property; and
wherein selecting the second task system further comprises:
determining one or more properties of the second reviewers of the second task system, and
selecting the second task system for the second task specification based on one or more properties of the second reviewers.
